(19) United States
(12) Patent Application Publication
(10) Pub. No.: US 2015/0143851 A1
(43) Pub. Date: May 28, 2015

(54) METHOD FOR PRODUCING A CYLINDRICAL COMPONENT FROM SYNTHETIC QUARTZ GLASS CONTAINING FLUORINE

(71) Applicant: Heraeus Quarzglas GmbH & Co. KG, Hanau (DE)

(72) Inventors: Martin Trommer, Bitterfeld (DE); Malte Schwerin, Halle (DE); Steffen Zwarg, Wolfen (DE)

(73) Assignee: Heraeus Quarzglas GmbH & Co. KG, Hanau (DE)

(21) Appl. No.: 14/395,468

(22) PCT Filed: Apr. 16, 2013
(86) PCT No.: PCT/EP2013/057869

§ 371 Date: Oct. 17, 2014

(30) Foreign Application Priority Data
Apr. 17, 2012 (DE) 10 2012 007 520.0

(51) Int. Cl. C03B 37/014; C03B 37/018

(52) U.S. Cl. CPC C03B 37/01446; C03B 37/018; C03B 37/01453; C03B 2201/075; C03B 2201/12
USPC 65/397

(57) ABSTRACT

The following method steps are known for producing cylindrical components from synthetic quartz glass containing fluorine: producing a SiO₂ soot body, removing hydroxyl groups from the soot body, loading the soot body with fluorine, post-chlorinating the soot body loaded with fluorine, and vitrifying the soot body to form the cylindrical component. In order to achieve distributions in particular of fluorine that are especially reproducibly homogeneous axially and radially, according to the invention it is proposed that a concentration of hydroxyl groups in the range of 1 to 300 weight ppm is set in the soot body upon the drying and an average fluorine content of at least 1500 weight ppm is set upon the loading with fluorine, and that loading with chlorine occurs during the post-chlorination, which loading results in an average chlorine content of at least 50 weight ppm in the synthetic quartz glass after the vitrification, under the further stipulation that the weight ratio of the contents of fluorine and chlorine is less than 30.

The present invention refers to a method for producing a cylindrical component of fluorine-containing synthetic quartz glass, the method comprising the following steps:
(a) producing a soot body by flame hydrolysis or oxidation of a silicon-containing starting compound and depositing SiO₂ particles on a carrier,
(b) removing hydroxyl groups by subjecting the soot body to a dehydration treatment,
(c) loading the soot body with fluorine by treating said body in a fluorine-containing atmosphere at a fluorination temperature of at least 750° C.,
(d) post-chlorination of the fluorine-loaded soot body by treating said body in a chlorine-containing atmosphere at a post-chlorination temperature, and
(e) vitrifying the soot body to obtain a cylindrical component of synthetic quartz glass by heating said body to a vitrification temperature.

The doping of quartz glass with fluorine will reduce the refractive index. Fluorine-doped quartz glass is therefore used for producing light-conducting refractive index structures in optical fibers. As a semifinished product for such optical fibers, either a preform is used which in radial direction has a refractive index profile and which can directly be drawn into the fiber, or a rod-shaped or tubular cylinder is used which comprises at least one layer consisting of the fluorine-doped quartz glass. This cylinder can be elongated into the fiber together with other cylindrical components as an ensemble in a coaxial arrangement. Such fluorine-doped quartz glass cylinders are also used in laser and semiconductor fabrication.

### PRIOR ART

A method and a quartz-glass component of the aforementioned type are known from US 2003/0221459 A1. A preform of porous SiO₂ soot is produced with the help of an OVD (outside vapor deposition) method. Said preform is doped in a central region with GeO₂, and said region is surrounded by a cladding of undoped porous SiO₂ material.

The soot preform is introduced into a furnace and subjected therein to a plurality of hot treatment steps. This includes a first chlorination step for removing hydroxyl groups in a chlorine-containing atmosphere at a temperature ranging from 1000° C. to 1225° (total treatment duration: about 90 min), a fluorine loading step in which the soot preform is treated in SiF₄-containing and Cl₂-containing atmosphere at a fluorination temperature of 1225° C. (total treatment period: about 30 min), a second chlorination step in a Cl₂-containing atmosphere at a post-chlorination temperature of 1225° C., and a completing vitrification of the soot body to obtain a body of synthetic quartz glass in an atmosphere of helium (He) and carbon monoxide (CO) at a vitrification temperature of 1460° C.

The second chlorination step in Cl₂ atmosphere serves to remove further hydroxyl groups from the soot body or to introduce chlorine especially into the cladding region of the soot body. By loading the cladding region with chlorine the viscosity in this region is to be adapted in an improved way to the viscosity in the GeO₂-doped core region, resulting in less mechanical stresses in the fiber drawing process.

The central region of the preform obtained in this way contains up to 19% by wt. of GeO₂, and it is doped with fluorine over its whole diameter. The fluorine concentration varies between 0.3% by wt. and 0.75% by wt. Moreover, the preform contains chlorine, namely about 0.01-0.13% by wt. in the GeO₂-doped region and, otherwise, between 0.003% by wt. and 0.07% by wt.

US 2008/0050086 A1 describes a special optical fiber with a core of SiO₂, doped with alkali oxides, and a cladding of pure quartz glass. The core material contains few hydroxyl groups (<0.02 ppm), but relatively great amounts of fluorine (>500 ppm) and chlorine (>500 ppm). The amounts of fluorine and chlorine are each greater than the amount of alkali oxides. The core is composed of an inner core region and an outer core region. The fluorine content is <5000 ppm by weight, averaged over the whole core.

### TECHNICAL OBJECT

To ensure a reproducible light conduction in the optical fiber, the observation of a given fiber geometry as well as a defined radial and axial profile of the refractive index are imperative. The chemical composition of the quartz glass may have an effect on both the refractive index and the viscosity of the quartz glass and thus on the setting of the geometry in the fiber drawing process. Therefore, it is a quality feature of the cylindrical component to ensure a defined axial and radial profile of the chemical composition.

In high-temperature treatments for the purpose of loading the porous soot body with fluorine or chlorine via the gas phase or for removing hydroxyl groups from the soot body, diffusion processes play a decisive role. Hydroxyl groups can react with both fluorine and chlorine while forming hydrogen compounds. Different diffusion rates and reactivities of the components tend to yield axially or radially inhomogeneous concentration profiles. What is however desired are concentration distributions that are as uniform as possible.

It is therefore the object of the present invention to indicate a method which makes it possible to produce cylindrical components in a reproducible and reliable way from synthetic, fluorine-doped quartz glass with an axially and radially particularly homogeneous distribution of the substance components.

### GENERAL DESCRIPTION OF THE INVENTION

Starting from a method of the aforementioned type, this object is achieved according to the invention in

(I) that in the dehydration treatment according to method step (b) a concentration of hydroxyl groups is set in the soot body that after vitrification yields a mean hydroxyl group content in the range of 1 wt.-ppm to 300 wt.-ppm,
(II) that during loading of the soot body with fluorine according to method step (c) loading with fluorine is carried out that after vitrification yields a mean fluorine content of at least 1500 wt.-ppm in the synthetic quartz glass of the component, and
(III) that during post-chlorination according to method step (d) in the soot body
a hydroxyl group content is set that after vitrification yields a mean hydroxyl group content of less than 0.3 wt.-ppm in the synthetic quartz glass of the component, and
loading with chlorine is carried out such that after vitrification a mean chlorine content of at least 50 wt.-ppm is obtained in the synthetic quartz glass of the component, with the further proviso that the weight ratio of the contents of fluorine and chlorine is less than 30.

The soot body is a hollow cylinder or a solid cylinder consisting of porous SiO₂ soot obtained according to the known VAD (vapor axial deposition) method or according to the OVD (outside vapor deposition) method. To produce the soot body, SiO₂ particles are produced from a silicon-containing starting substance in a CVD (chemical gas phase deposition) method by hydrolysis and/or oxidation, and these are deposited on a carrier. The temperature during the deposition of the SiO₂ particles is kept so low that a rod-shaped or tubular soot body of porous quartz glass is obtained. In an OVD method, deposition takes place on the outside surface of a tubular or rod-shaped carrier. This carrier is subsequently removed, or it remains in the bore of the soot body. A carrier remaining in the bore consists of doped or undoped quartz glass and forms part of the quartz glass component to be produced.

The soot body is subjected to a multi-stage post-treatment. First of all, a dehydration treatment has to be paid attention to, for soot bodies normally contain a high content of hydroxyl groups (OH groups) due to the manufacturing process. Apart from the initial hydroxyl group content and the mean hydroxyl group content to be achieved, the necessary duration and efficiency of the drying process depends essentially on the soot density.

During the dehydration treatment the soot body is dried in a purely thermal way by heating in vacuum (<2 mbar) or in a chlorine-free inert gas atmosphere (noble gas or nitrogen) or as an alternative or in addition thereto it is dried chemically using a drying reagent such as chlorine or fluorine. The dehydration treatment is carried out at an elevated temperature at any rate, but a substantial densification of the soot body is not desired. It is important that one obtains a concentration of hydroxyl groups in the soot body that is of such a kind that if the soot body was vitrified in this process stage under vacuum, a mean hydroxyl group content of less than 300 wt.-ppm would be obtained.

It has been found that the hydroxyl group content is conducive to an efficient loading of the soot body with fluorine in the subsequent method step. This might be due to the substitution of OH groups by fluorine. Therefore, a high mean hydroxyl group content facilitates the setting of a high mean fluorine content, whereas in the case of a low hydroxyl group content a lower loading of the soot body with fluorine is possible.

However, after the dehydration treatment the hydroxyl group distribution is normally axially and radially inhomogeneous, and the initial profile of the fluorine distribution obtained after fluorine loading is mainly congruent with the prevailing hydroxyl-group distribution profile. The hydroxyl groups are either substantially eliminated prior to fluorine loading, which will yield a low fluorine concentration, but with a substantially flat fluorine distribution profile, or the dehydration treatment is carried out such that a comparatively high hydroxyl group content of up to 300 wt.-ppm is maintained—this will yield a correspondingly higher fluorine concentration, but with the disadvantage of an initially inhomogeneous distribution.

In this respect the range between 1 and 300 wt.-ppm for the hydroxyl group concentration is a suitable compromise between a high fluorine content on the one hand and an already initially homogeneous fluorine distribution after the fluorine loading step. It will be explained hereinafter in more detail that it is possible to accept an initially inhomogeneous fluorine distribution in the method according to the invention in favor of a high fluorine loading of the soot body because a flattening of the fluorine distribution profile is achieved in a subsequent method step, namely during post-chlorination.

In the fluorine treatment step, the soot body is treated at a high temperature with a fluorine-containing treatment gas such as C₂F₆, CF₄, or SiF₄. Fluorine serves to lower the refractive index of quartz glass. Chlorine has less influence on the refractive index.

In the sense of a high refractive-index reduction, one therefore aims at a loading of the soot body with fluorine that is as high as possible, namely at a level which after vitrification of the soot body in vacuum yields a mean fluorine content of at least 1500 wt.-ppm in the synthetic quartz glass of the component that is then obtained. The temperature is kept so low during loading that there is no significant thermal densification of the soot body, if possible, which densification would impair the subsequent process.

However, due to the diffusion and reaction processes involving hydroxyl groups and fluorine, an insufficiently homogeneous distribution of the fluorine concentration especially in radial direction is frequently observed within the soot body wall after fluorine doping. As has been explained above, the axial and radial distribution resulting after fluorine doping decisively depends on the hydroxyl-group concentration profile found.

In the subsequent post-chlorination according to method step (d) the soot body is treated with a chlorine-containing treatment gas, such as Cl₂, at about the same high temperature or at a slightly higher temperature in comparison with the preceding fluorine loading,

It has been found that although post-chlorination leads to a certain decrease in the fluorine concentration, this is acceptable because at the same time it is possible to significantly smooth a fluorine distribution profile that has not been sufficiently homogeneous before.

Therefore, in the method according to the invention it is possible to accept an initially high mean hydroxyl group content in the soot body, accompanied by an inhomogeneous radial concentration distribution both of the hydroxyl groups and fluorine, in favor of a flat radial fluorine concentration distribution.

Post-chlorination is of course accompanied by a loading of the soot body with chlorine or its further loading with chlorine. The concentration ratio of fluorine and chlorine has turned out to be a simple indication that this measure effects an adequate smoothing of the fluorine distribution profile. According to the invention this ratio does not exceed the value 30 (in weight units), which means that the mean fluorine concentration is not more than 30 times higher than the mean chlorine concentration, and this concentration is moreover not lower than 50 wt.-ppm.

Due to this relatively high loading of the soot body with halogens, one obtains a low hydroxyl group content of less than 0.3 wt.-ppm after vitrification of the soot body.

To ensure that the post-chlorination process fulfills this significant effect on the radial distribution of the fluorine concentration, the described boundary conditions (I) to (III) must be observed in the preceding treatment steps (a) to (d), as shall be substantiated in more detail hereinafter.

The quartz glass produced after vitrification of the soot body contains fluorine, chlorine and—to a minor extent—hydroxyl groups. All of these components effect a reduction of the viscosity of quartz glass. In the infrared wavelength range, hydroxyl groups exhibit absorption, so that the hydroxyl group in the quartz glass is as low as possible. Fluorine and chlorine do not significantly impair transmission in the wavelength range of relevance to optical signal transmission, but have an impact on the refractive index of the quartz glass; this is particularly true for fluorine. To set optical characteristics in radial and axial direction that are as homogeneous as possible, a distribution of the components chlorine and particularly fluorine that is as homogeneous as possible is therefore of decisive importance.

The degree of porosity of the soot body influences the progress and result of treatment steps (b), (c) and (d). Moreover, the soot density has also an influence on other gas phase reactions for loading the soot body with components or for removing components from the soot body.

It has turned out to be advantageous when in the deposition process according to method step (a) a soot body is produced with a mean density of at least 20% and not more than 30%.

A mean density of more than 35% leads to respectively long treatment durations, and greater gradients in the radial concentration profile of the above-mentioned components are likely. A lower density of the soot body facilitates the introduction of the components and the setting of a radially homogeneous concentration profile. In the case of soot densities of less than 20%, it becomes however more and more difficult to vitrify the soot body without any bubbles. The density data regard the density of undoped synthetic quartz glass of (2.21 g/cm³).

A particularly suitable compromise between homogeneity of the fluorine and chlorine concentration profiles on the one hand and the suitability of the soot body for a reproducibly bubble-free vitrification on the other hand is achieved if in the deposition process according to method step (a) a soot body is produced with a mean density in the range between 25% and 30%.

In a preferred embodiment of the method according to the invention, the dehydration treatment comprises a heating of the soot body in vacuum or in inert gas in a chlorine-free atmosphere.

In contrast to the above-cited prior art, the dehydration treatment is here not carried out by heating the soot body in a halogen-containing atmosphere, but is performed in vacuum at a pressure of not more than 2 mbar or in an inert gas, which substantially stands for noble gases and nitrogen. This prevents an input of halogens into the soot bodies prior to the fluorine loading, and a certain hydroxyl group content is maintained. It has been found that loading with fluorine is thereby carried out more efficiently, which means that a predetermined mean fluorine content is achieved at a faster pace. This can be ascribed to the fact that coupling points preferred for fluorine atoms in the SiO₂ network are not already occupied by a halogen.

A significant densification of the soot body during post-chlorination may lead to an insufficiently homogeneous distribution of the fluorine concentration in radial direction in the vitrified quartz glass component. With respect to this it has turned out to be useful when post-chlorination encompasses a heating of the soot body to a temperature in the range between 750° C. and 1200° C.

A particularly low hydroxyl group content of the quartz glass component obtained according to the present method is above all required in cases where the quartz glass is to be used as a near-core cladding material of an optical fiber. The hydroxyl group content, as obtained after the dehydration treatment, is still too high as a rule. It has therefore turned out to be useful when due to post-chlorination a concentration of hydroxyl groups is set in the soot body that after vitrification yields a mean hydroxyl group content of less than 0.2 ppm by weight in the synthetic quartz glass of the component.

With respect to a concentration profile of both fluorine and chlorine that is as flat as possible, it has turned out to be advantageous when the fluorine content during loading according to method step (c) and the chlorine content during post-chlorination according to method step (d) are set such that, in weight proportions, the fluorine content is less than 15 times the chlorine content.

It has also turned out to be useful when the vitrification of the soot body according to method step (e) is carried out zone by zone.

The dried soot body which is loaded with fluorine and chlorine is introduced in the end into a vacuum vitrification furnace and is supplied, starting with its one end, continuously to an annular heating element and is heated therein zone by zone.

During vitrification a melt front travels within the soot body from the outside to the inside and, at the same time, from one end to the other one. By comparison with isothermal vitrification, in which the whole soot body is simultaneously vitrified within a sufficiently long heating zone over its whole length, and the melt front only travels from the outside to the inside, zone-wise sintering facilitates the diffusion and distribution of gases within the soot body wall. It has been found that axially more uniform concentration profiles of the components fluorine and chlorine are thereby achieved.

This effect is even intensified when the soot body is again dried thermally prior to vitrification by heating it at a temperature below the vitrification temperature, namely preferably zone by zone by passing it once or repeatedly through the annular heating element.

The quartz glass produced according to the method of the invention is particularly suited for use in a near-core cladding region of an optical fiber. In this respect it is advantageous when the hydroxyl group content of the quartz glass is less than 0.2 wt.-ppm.

### EMBODIMENT

The invention shall now be explained in more detail hereinafter with reference to an embodiment and a drawing. In detail,

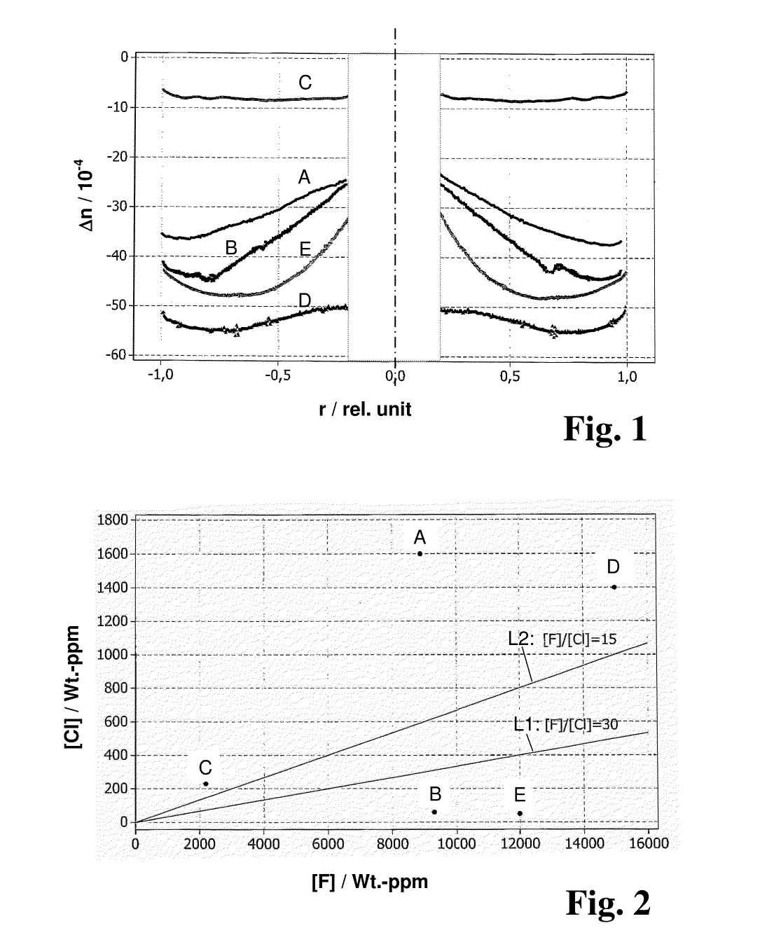

FIG. 1 shows a diagram with radial refractive-index profiles in the case of different cylindrical quartz-glass samples;

FIG. 2 shows a scatter diagram with measurement points of the chlorine and fluorine concentrations of different quartz-glass samples; and

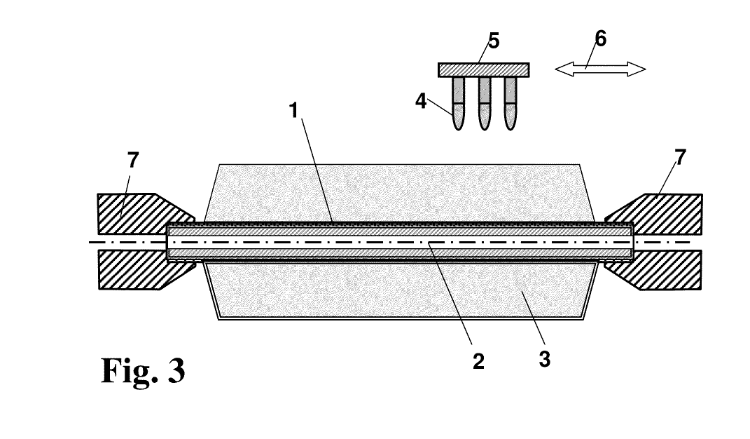

FIG. 3 shows an apparatus suited for producing a SiO₂ soot body, in a schematic illustration.

The apparatus shown in FIG. 3 comprises a carrier tube 1 which is clamped at both sides in clamping jaws 7 of a glass lathe and is rotatable about its longitudinal axis 2. To produce a SiO₂ soot, deposition burners 4 of quartz glass are provided; these are mounted at a distance of 150 mm each on a joint slide 5 which is reversingly movable along the carrier tube 1 between the ends of the evolving soot body 3, as outlined by the directional arrow 6, and which is movable in a direction perpendicular thereto.

To produce a SiO₂ body 3, the deposition burners 4 are each fed with oxygen and hydrogen as burner gases, and a gas stream which contains SiCl₄ is supplied as feedstock for forming the SiO₂ particles. These components are converted in the respective burner flame into SiO₂ particles, and these are deposited layer by layer on the carrier tube 1 while forming the porous SiO₂ soot body 3. The slide 5 with the deposition burners 4 is here reciprocated with a translational speed of 100 mm/min along the evolving soot body 3 between the ends thereof.

The soot body deposition process will be terminated as soon as the soot body 3 has an outer diameter of about 350 mm. After cooling the carrier is drawn from the bore of the soot body 3.

The soot tube 3 is subsequently subjected to a dehydration treatment (drying) which is either implemented as hot chlorination or as purely thermal drying.

In the case of hot chlorination the tubular soot body 3 is introduced into a dehydration furnace and heated therein to a temperature of about 900° C. and is treated at that temperature in a chlorine-containing atmosphere for a period of several hours. In the case of purely thermal drying, the soot body is treated at a temperature of at least 1050° C. in nitrogen in a flushing operation.

At any rate the dehydration treatment has the effect that one obtains a mean hydroxyl group content in the range of 1-300 wt.-ppm in the soot body. The parameters of the dehydration treatment and the respectively resulting hydroxyl group contents are indicated in Table 1. The hydroxyl group contents in this method stage are measured in that the soot body is vitrified in vacuum in the standard way (as also described below) and the mean hydroxyl group concentration is determined by IR spectroscopy on the vitrified component. Due to the vitrification of the soot body the original hydroxyl group content may still change; hence, these are just reference values the predictive value of which follows substantially from a comparison with other hydroxyl group concentrations determined in this way. Attention must also be paid that the drying process is diffusion-controlled, so that the mean hydroxyl group content obtained in the end after the dehydration treatment and the hydroxyl group distribution depend on the geometry of the soot body.

For loading with fluorine the dried soot tube 3 is subsequently introduced into a doping furnace and exposed at a high temperature to an atmosphere which contains fluorine-containing substances. The parameters and results of fluorine-loading are also indicated in Table 1.

Fluorine can here react with the existing hydroxyl groups and replace the same fully or in part. Therefore, this results in a fluorine loading which depends on the hydroxyl group content and which is normally the higher the higher the hydroxyl group content is, and which is approximately congruent with the hydroxyl group distribution found. High hydroxyl group contents are often accompanied by a great axial and radial concentration gradient, whereas low hydroxyl group contents also have a low axial and radial absolute concentration gradient from the start. The axial/radial distribution of the fluorine concentration is thus obtained during fluorine loading. Since the invention also aims at a high concentration of fluorine, this may stand for the acceptance of a fluorine distribution profile that is first not sufficiently homogeneous.

The mean fluorine contents in this process stage are measured, as has been explained above for the approximate estimation of the hydroxyl group contents of the soot body 3, in that the soot body 3 is vitrified in vacuum in the standard way and the mean fluorine concentration is determined in a wet-chemical process on the vitrified component.

During subsequent post-chlorination the fluorine-loaded soot tube 3 is treated at an approximately equally high temperature with a chlorine-containing treatment gas. The parameters and results of the post-chlorination process are also indicated in Table 1.

Post-chlorination makes it possible for the fluorine as a chemical compound (such as SiF₄) or as a free fluorine molecule to spread more homogeneously within the soot body 3 and to react with the SiO₂ network. This spreading or distribution is evidently promoted by the presence of chlorine. Such processes may contribute to a significant smoothing of a fluorine distribution profile that has not been sufficiently homogeneous before without the preset mean fluorine concentration decreasing to an extent that is no longer acceptable. Post-chlorination is accompanied by a loading of the soot body with chlorine or its further loading with chlorine. Since post-chlorination provides for an adequate smoothing of the preset fluorine distribution profile, a minimum chlorine loading is achieved, this loading being the higher, the higher the desired mean fluorine content is.

At the same time the intensive treatment with the halogens fluorine and chlorine automatically yields a lower hydroxyl group content. The initially contained hydroxyl groups thereby just serve as intermediaries for a high average fluorine loading of the quartz glass.

The soot tube 3 treated in this way is subsequently introduced into a vacuum vitrification furnace with vertically oriented longitudinal axis and is supplied, beginning with its lower end, at a feed rate of 5 mm/min continuously from above to an annular heating element and is heated zone by zone. The temperature of the heating element is preset to 1400° C. During sintering a melt front travels within the soot tube 3 from the outside to the inside and simultaneously from the top to the bottom. The internal pressure inside the vitrification furnace is kept by continuous evacuation at 0.1 mbar during sintering.

A quartz glass tube (outer diameter: 150 mm) is thereby obtained with an inner diameter of 50 mm, the tube containing fluorine and chlorine and being further distinguished by high purity, particularly by a low hydroxyl group content. The quartz glass tube is suited for use in the near-core area of a preform for optical fibers—for instance as a substrate tube for inside deposition by way of MCVD method. The quartz glass tube is e.g. also suited for overcladding a core rod during fiber drawing, for producing a preform, or as a semifinished product for the manufacture of quartz glass tubes for laser and semiconductor applications.

The physical properties of the samples mentioned in Table 1 were determined on the basis of the following methods.

### (i) Measurement of the Concentration of OH Groups

The measurement was carried out with the help of the method as described by “D. M. Dodd and D. B. Fraser, Optical determination of OH in fused silica, Journal of Applied Physics, Vol. 37(1966), p. 3911.”

### (ii) Measurement of the Chlorine Concentration

The measurement was carried out by dissolving the test sample in aqueous HF solution and by subjecting the solution obtained thereby to a nephelometric analysis after addition of AgNO_{3.}
   (iii) Measurement of the Fluorine Concentration
The measurement was carried out by dissolving the test sample in aqueous NaOH solution and by determining the F concentration by means of an ion electrode method.

### (iv) Measurement of the Radial Concentration Profiles for Fluorine and Chlorine, Respectively, and Determination of the Mean Values

In the tubular quartz glass material with a wall thickness of 80 mm and with a length of 50 mm, the respective concentration is measured at about 60 points at the interval distance of 1 mm over the wall by means of X-ray fluorescence analysis (EBMA).

### (v) Measurement of the Metallic Impurities Contained in the Quartz Glass

The concentration of the impurities of Na, K, Mg, Ca, Fe was determined by atomic absorption spectroscopy, and the impurities of Li, Cr, Ni, Mo and W were determined by inductively coupled plasma mass spectroscopy (ICP-MS).

TABLE 1

| | | A | B | C | D | E |
|---|---|---|---|---|---|---|
| Soot density (%) | | 28 | 28 | 28 | 27 | 20 |
| Drying | Method | thermal | thermal | chlorination | thermal | thermal |
| | T(° C.) | 1,000 | 1,000 | 880 | 1,000 | 1,000 |
| | t (h) | 15 | 15 | 12.3 | 15 | 12 |
| | [OH] (ppm) | 250 | 250 | 1 | 200 | 250 |
| Fluorine loading | Gas | C₂F₆ | C₂F₆ | C₂F₆ | CF₄ | C₂F₆ |
| | T(° C.) | 1,000 | 1,000 | 880 | 1,100 | 1,000 |
| | t (h) | 12 | 12 | 12.3 | 12 | 8 |
| Post-chlorination | T(° C.) | 1,000 | — | 880 | 1,000 | — |
| | t (h) | 8 | — | 3 | 8 | — |
| Measurement | [F] (ppm) | 8,900 | 9,300 | 2,200 | 15,000 | 12,000 |
| results | [Cl] (ppm) | 1,600 | 60 | 230 | 1.400 | 50 |
| | [OH] (ppm) | 0.06 | 0.2 | 0.1 | 0.05 | 0.05 |
| | ΔFluorine (ppm) | 2,300 | 4,300 | 700 | 1,500 | 3,500 |
| | ΔChlorine (ppm) | 600 | n.d. | 120 | 300 | n.d |
| | [F]/[Cl] | 5.6 | 155 | 9.6 | 10.7 | 240 |

In Table 1, all of the concentration data refer to weight proportions.

Δfluorine (ppm) and Δchlorine (ppm) mark the difference between minimum value and maximum value of the radial concentration profile (if unambiguous boundary effects are disregarded).

“n.d.” means “not measurable”.

In the line “drying method”, “chlorination” stands for hot chlorination, and “thermal” stands for thermal drying at a high temperature under nitrogen without addition of a halogen to the drying atmosphere (as described above).

All samples were subjected to a post-chlorination, with the exception of Samples B and E. The chlorine content which could nevertheless be measured in these samples is due—on account of the manufacturing process—to the use of the chlorine-containing SiCl₄ as starting substance for SiO₂ soot body production. The measurement values are close to the detection limit of the measurement method.

Although Samples B and E allow high fluorine loading, due to the missing chlorine post-treatment an unfavorable radial fluorine concentration distribution is achieved with a high Δfluorine value, as can be seen from the measurement results of Table 1 and as shall be explained in more detail with reference to FIG. 1. A high concentration ratio [F]/[Cl] of 155 (Sample B) and of 240 (Sample E), respectively, is regarded as a measure of this disadvantageous radial concentration distribution, as shall be considered in more detail further below with reference to FIG. 2.

In Sample C, an initially low hydroxyl group content in the soot body, which after fluorination manifested itself in a comparatively low fluorine content, was obtained due to the efficient drying by chlorination. The maximum concentration difference Δfluorine is lower and also the chlorine content of the end product, which manifests itself in a small concentration ratio [F]/[Cl] of 9.6.

Samples A and D differ substantially in the intensity of the fluorine loading. Both samples exhibit a high chlorine content and a relatively flat fluorine concentration profile that is expressed in a small concentration ratio [F]/[Cl] of 5.6 (Sample A) and of 10.7 (Sample D), respectively.

Apart from post-chlorination, Samples A and B do not differ. This is true—though less unambiguously—to a certain extent also to a direct comparison of Samples D and E. These comparisons show that post-chlorination—at any rate under the prevailing conditions by drying and fluorination—leads to a significant flattening of the radial fluorine concentration profile. This is illustrated by the respective small Δfluorine values and by FIG. 2, as will be explained in more detail hereinafter.

The concentration of the impurities of Li, Na, K, Mg, Ca and Fe is in all samples in the range of less than 5 wt. ppb. The concentration of the impurities of Cu, Cr, Ni, Mo and Mn is less than 1 wt. ppb.

FIG. 1 shows the radial refractive index profiles of Samples A to E. These are substantially reflected in the radial distribution of the fluorine concentration because chlorine and hydroxyl groups have a much less pronounced effect on the refractive index than the fluorine content. On the y-axis, the refractive difference Δn is plotted against undoped quartz glass (hereinafter also called “refractive index jump”). The refractive index of undoped quartz glass forms the zero value, starting from which one achieves a refractive index reduction by way of fluorine doping. On the x-axis, the radial position r (standardized to the sample radius) is plotted. The value zero corresponds to the tube center axis.

It follows from this illustration that although Samples B and E, which are not post-chlorinated, exhibit a great refractive index jump, this is accompanied by a very inhomogeneous radial fluorine concentration distribution. Both the high mean fluorine content and the inhomogeneous radial fluorine distribution can be ascribed to a correspondingly inhomogeneous prevailing distribution of the hydroxyl groups in the case of fluorine loading. On account of their unfavorable radial fluorine distribution in the end product, Samples B and E represent comparative examples for the invention.

The low mean fluorine content of Sample C induces a small refractive index jump of about −8×10⁻⁴ in comparison with undoped quartz glass. On the other hand, this sample shows the flattest radial fluorine distribution of all tests and is thus still regarded as an example of the invention.

A similar flat radial refractive-index profile was only found in Sample D and—though to a poorer degree—in Sample A.

The common characteristic of Samples A, C and D of the invention is the small number for the concentration ratio [F]/[Cl]. FIG. 2 shows—by way of a scatter diagram—the distribution of the chlorine and fluorine concentrations of Samples A to D in a two-dimensional composition area. The respective concentration of chlorine is plotted on the y-axis (in wt.-ppm), and the associated concentration of fluorine is plotted (in wt.-ppm) on the x-axis. Moreover, two lines L1 and L2 are drawn. The steeper the lines extend, the lower is the content of fluorine in relation with chlorine.

In the case of L2 the concentration ratio is [F]/[Cl]=30, and above line L2 the fluorine content is less than 15 times the chlorine content.

Samples A, C and D according to the invention, which are all distinguished by an acceptable flat radial profile of the fluorine concentration distribution, are all within the composition area above L1 and also above line L2. It is therefore assumed that the concentration profile [F]/[Cl] is a measure of the radial fluorine concentration distribution, and that a flat concentration profile presupposes a ratio [F]/[Cl] of less than 30, preferably of less than 15.

1. A method for producing a cylindrical component of fluorine-containing synthetic quartz glass, said method comprising:
(a) producing a soot body by flame hydrolysis, or oxidation, of a silicon-containing starting compound and depositing SiO₂ particles on a carrier,
(b) removing hydroxyl groups by subjecting the soot body to a dehydration treatment,
(c) loading the soot body with fluorine by treating the soot body in a fluorine-containing atmosphere at a fluorination temperature of at least 750° C.,
(d) post-chlorination of the fluorine-loaded soot body by treating said body in a chlorine-containing atmosphere at a post-chlorination temperature, and
(e) vitrifying the soot body to obtain the cylindrical component by heating the soot body to a vitrification temperature, wherein
(I) in the dehydration treatment a concentration of hydroxyl groups is set in the soot body such that, after vitrification, the cylindrical component has a mean hydroxyl group content in a range of 1 wt.-ppm to 300 wt.-ppm,
(II) the loading of the soot body with fluorine is carried out such that after vitrification the cylindrical component has a mean fluorine content of at least 1500 wt.-ppm in the synthetic quartz glass of the component, and
(III) during the post-chlorination in the soot body
a hydroxyl group content is set such that after vitrification the cylindrical component has a mean hydroxyl group content of less than 0.3 wt.-ppm in the synthetic quartz glass of the component, and
the loading of the soot body with chlorine is carried out such that after vitrification the synthetic quartz glass of the component has a mean chlorine content of at least 50 wt.-ppm, and wherein the weight ratio of the mean fluorine content to the mean chlorine content is less than 30.

2. The method according to claim 1, wherein the soot body has a mean density of at least 20% and not more than 35%.

3. The method according to claim 1, wherein the dehydration treatment comprises heating the soot body in vacuum or in an inert gas in a chlorine-free atmosphere.

4. The method according to claim 1, wherein the fluorine content during the loading of the soot body with fluorine and the loading with chlorine during the post-chlorination is such that, in the synthetic quartz glass of the component, the fluorine content [—in weight proportions—] is less than 15 times the chlorine content, by weight.

5. The method according to claim 1, wherein the post-chlorination comprises a heating of the soot body to a temperature in the range between 750° C. and 1200° C.

6. The method according to claim 1, wherein the post-chlorination sets a concentration of hydroxyl groups in the soot body such that after the vitrification the mean hydroxyl group content in the synthetic quartz glass of the component, is less than 0.2 wt.-ppm.

7. The method according to claim 1, wherein the vitrification of the soot body is carried out zone by zone.

8. The method according to claim 7, wherein the vitrification comprises a zonewise pre-heating of the soot body to a temperature below the vitrification temperature.

9. The method according to claim 1, wherein the soot body has a mean density in a range between 25% and 30%.
